(19) United States
(12) Patent Application Publication
(10) Pub. No.: US 2026/0197816 A1
(43) Pub. Date: Jul. 9, 2026

(54) SYSTEM AND METHOD FOR DYNAMIC ALLOCATION OF RESOURCES BASED ON SLICE RESOURCE AVAILABILITY

(71) Applicant: Verizon Patent and Licensing Inc., Basking Ridge, NJ (US)

(72) Inventors: Kamalaharan Dushyanthan, Bridgewater, NJ (US); Chin Chiu, Allen, TX (US); Asif Dawoodi Gandhi, Edison, NJ (US)

(21) Appl. No.: 19/009,075

(22) Filed: Jan. 3, 2025

(51) Int. Cl. H04W 72/121; H04W 28/02; H04W 28/24; H04W 72/54

(52) U.S. Cl. CPC H04W 72/121; H04W 28/0268; H04W 28/24; H04W 72/54

(57) ABSTRACT

A device may include a processor. The processor may be configured to: identify first RAN slices with more physical resource blocks (PRBs) assigned to the first Radio Access Network (RAN) slices than a number of PRBs that the first RAN slices need for first radio access network (RAN) communication from an access station to User Equipment devices (UEs); identify one or more second RAN slices that need more PRBs than a number of PRBs assigned to the one or more second RAN slices for second RAN communication from the access station to UEs; and instruct the access station to schedule PRBs that are not needed by the first RAN slices for the second RAN communication to the UEs.

### BACKGROUND INFORMATION

Fifth Generation (5G) networks include network slicing. Network slicing allows operators to create multiple virtual networks on a shared physical infrastructure. This capability optimizes resource usage, reduces costs, and enables tailored service delivery for diverse applications, such as ultra-reliable low-latency communication (e.g., autonomous vehicles) and massive Internet-of-Things (IoT) deployments. By allowing services to scale independently within each slice, network slicing enhances performance, flexibility, security, and latency, while also facilitating faster rollout of new services without significant changes to the existing infrastructure.

### BRIEF DESCRIPTION OF THE DRAWINGS

FIG. 1 illustrates an overview of a system described herein.

FIG. 2 illustrates an exemplary network environment in which systems and methods described herein may be implemented.

FIG. 3A illustrates exemplary components of Radio Access Network (RAN) Intelligent Controller (RIC), according to an implementation.

FIG. 3B illustrates exemplary components of an access station that includes a RIC, according to an implementation.

FIG. 4 illustrates an exemplary process that is associated with RIC, according to an implementation.

FIG. 5 illustrates example factors related to Service Level Agreement (SLA) policies for dynamic allocation of physical resource blocks (PRBs), according to an implementation.

FIG. 6 illustrates an example assignment of PRBs to a RAN slice based on one or more of the factors, according to an implementation.

FIG. 7 is a flow diagram of an exemplary process for allocating PRBs that are associated with a RAN slice based on Quality-of-Service (QoS) traffic priorities, according to an implementation.

FIG. 8 shows a table of PRBs demanded by and assigned to QoS traffic types on different RAN slices, according to an implementation.

FIG. 9 is a flow diagram of an exemplary process for allocating PRBs that are associated with a RAN slice based on RAN slice priorities, according to an implementation.

FIG. 10 shows another table of PRBs demanded by and assigned to QoS traffic types on different RAN slices, according to an implementation.

FIG. 11 depicts exemplary functional components of a network device according to an implementation.

### DETAILED DESCRIPTION

The following detailed description refers to the accompanying drawings. The same reference numbers in different drawings may identify the same or similar elements. As used herein, the terms “service provider” and “provider network” may refer to, respectively, a provider of communication services and a network operated by the service provider. The network may be a cellular network. A cellular network may be uniquely identified by a Public Land Mobile Network (PLMN) Identifier (ID). As used herein, the term Radio Access Network (RAN) Intelligent Controller (RIC) may refer to logic (hardware and/or software) for optimizing and automating radio network functions using Artificial Intelligence (AI)/Machine Learning (ML) and/or other logic. A RIC may provide near real-time and/or non-real-time control to enhance network performance, flexibility, and efficiency for diverse use cases.

Systems and methods described herein relate to dynamic allocation of resources based on slice resource availability. More particularly, the systems and methods relate to dynamic allocation of physical resource blocks (PRBs) at access networks by a Radio Access Network Intelligent Controller (RIC) or another device. When multiple applications that require different levels of Quality-of-Service (QoS) traffic services share a radio access network (RAN) slice, each of the applications may cause the access network to use a certain number of PRBs allotted to the RAN slice. Among those applications, applications that require significant data throughput may require use of a larger share of the PRBs. In addition, UEs associated with these applications may be in adverse RF conditions, resulting in additional use of PRBs. Consequently, such PRB hungry applications may take larger shares of the total number of PRBs that the RAN slice may require for all of the applications serviced through the RAN slice. If PRB sharing between RAN slices is enabled, the PRB hungry applications may cause even larger shares to be used, as RICs typically rely on data burst volume at an application as a primary factor in determining resource allocation and slice sharing priorities. Consequently, higher priority applications and/or delay sensitive applications may experience degradation in network performance due to an unavailability of necessary PRBs (referred to as PRB starvation). The systems described herein use methods for dynamic PRB allocation that avoid such undesirable PRB starvation by high priority applications or applications assigned high priority RAN slices.

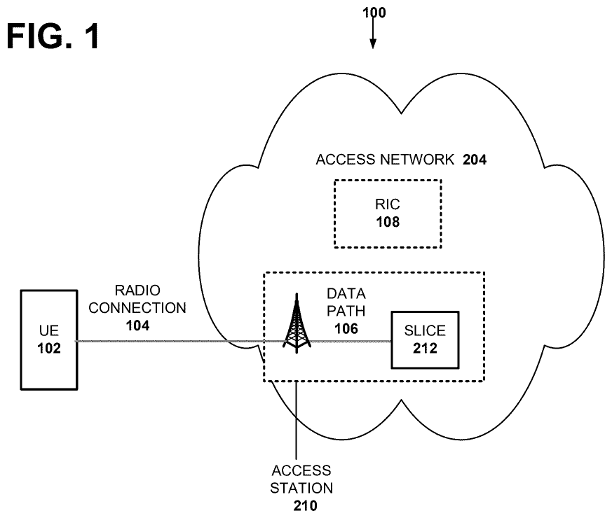

FIG. 1 illustrates the concepts described herein. As shown, network environment 100 includes a User Equipment device (UE) 102 and, access network 204 that includes RIC 108 and access stations 210, Access station 210 may in turn include RAN slices (e.g., a logical RAN portion). UE 102, which hosts a client application, may establish a radio connection 104 with an access station 210 in access network 204 to receive network services provided by the provider network. RAN slice 212 may define physical resources that access station 210 may use to deliver data to UE 102 via RAN slice 212. RIC 108 may optimize the communication between UE 102 and access station 210, as well as the operation of access network 204. In some implementations, the role of RIC 2108 may be provided by other devices in access network 204, such as a Central Unit (CU) or a another base station.

When UE 102 communicates with access station 210 over radio connection 104, the traffic may occupy a specific amount of time and a specific frequency, specified by PRBs. Depending on the amount of traffic between the application and the network, UE 102 and access station 210 may use various number of PRBs.

According to an implementation, RIC 204 may control access station 210 to regulate the number of PRBs that access station 210 use for conveying traffic over radio connection 104. More specifically, RIC 108 assigns a number of PRBs per each of RAN slices 212 and permits access station 210 to use the PRBs to communicate with UEs 102 over connections.

For example, if a particular RAN slice (call it RAN slice X 212) has PRBs that are not scheduled to be used by RAN slice X 212 (i.e., the PRBs not used by applications serviced via slice X 212 to communicate with the corresponding UE 102 over the connection), RIC 108 may instruct access station 210 to schedule the unused PRBs for transmitting/receiving data for applications assigned to use resources of another RAN slice 212 that needs more PRBs, for the applications to avoid PRB starvation. RIC 108 may generate the instructions based on its current PRB transfer policy. Once access station 210 receives the instruction, access station 210 may schedule data for transmission/reception for the applications serviced by the other RAN slice 212 to avoid PRB starvation.

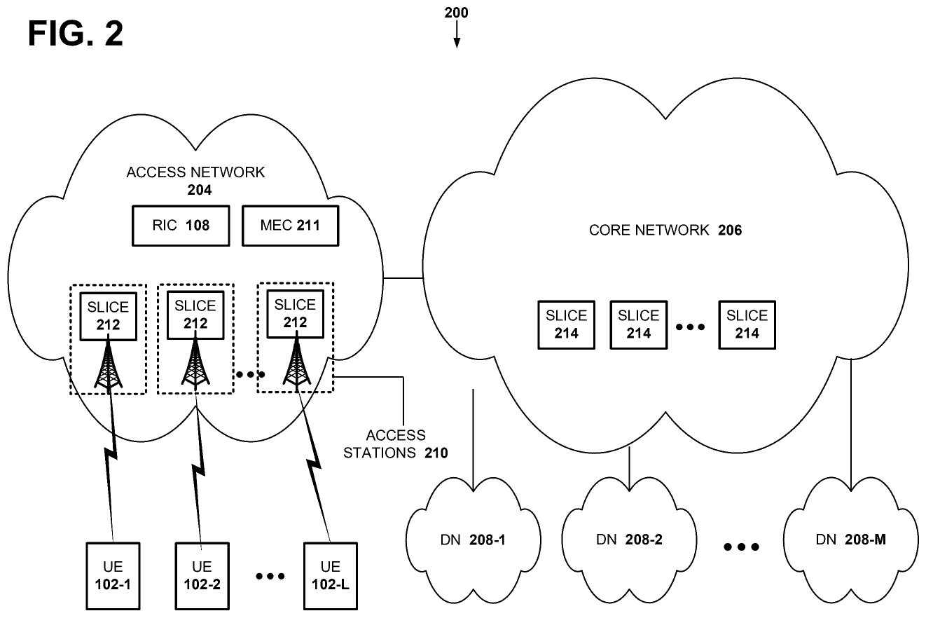

FIG. 2 illustrates an exemplary network environment 200 in which the systems and methods described herein may be implemented. As shown, network environment 200 may include UEs 102-1 through 102-L (collectively referred to as UEs 102 and generically referred to as UE 102), access network 204, core network 206, and data networks (DNs) 208-1 through 208-M (collectively referred to as data networks 208 and generically as data network 208). Access network 204, core network 206, and data networks 208 may be part of a provider network.

UEs 102 may include a wireless communication device capable of Fourth Generation (4G) (e.g., Long-Term Evolution (LTE)) communication, Fifth Generation (5G) New Radio (NR) communication, and/or other wireless communication. Examples of UE 102 include: a smart phone; a tablet device; a wearable computer device (e.g., a smart watch); a global positioning system (GPS) device; a laptop computer; a media playing device; a portable gaming system; an autonomous vehicle navigation system; a sensor; an Internet-of-Things (IoT) device; a Fixed Wireless Access (FWA) device; and a Customer Premises Equipment (CPE) device with 4G and 5G capabilities. In some implementations, UE 102 may include a wireless Machine-Type-Communication (MTC) device that communicates with other devices over a machine-to-machine (M2M) interface, such as LTE-M or Category M1 (CAT-M1) devices and Narrow Band (NB)-IoT devices.

UEs 102 may be associated with a user that is subscribed to the provider network. Each of UEs 102 may host one or more client applications (herein simply referred to as applications) that access services (herein also referred to as an application) provided by part of the provider network. The services may be provided by, for example, Multiaccess Edge Computing clusters, data networks 208, and/or RAN slices 212 in core network 204. As indicated above, to communicate with RAN slices 212 in core network 204, UEs 102 may establish wireless connections with access network 204 and send information using PRBs over the connections.

When the user of UE 102 or UE 102 is subscribed to the provider network, the network may render the services to UE 102 in accordance with the service level agreement (SLA) between UE 102 and the service provider. The SLA may specify, for example, parameters for one or more services (e.g., a guaranteed bit rate (GBR), traffic types, etc.) over the communication link between the UE 102 and the network, the maximum delay or latency, the maximum jitter, a maximum packet drop rate, and a minimum reliability.

Access network 204 may facilitate UE 102′s connection to core network 206 by establishing and managing over-the-air channels with UE 102 and backhaul channels with core network 206. These channels enable the relay of information between UE 102 and core network 206. Access network 204 comprises LTE, 5G NR, or other advanced radio access networks, featuring components such as central units (CUs), distributed units (DUs), radio units (RUs), and/or base stations. These network components are illustrated in FIG. 2 as access stations 210 (herein generically referred to as access station 210) for establishing and maintaining over-the-air channel with UEs 102. In some implementations, access station 210 may include a 4G, 5G, or another type of base station (e.g., evolved Node B (eNB), next generation Node B (gNB), etc.) that comprises one or more radio frequency (RF) transceivers. In some implementations, access station 210 may be part of an evolved Universal Mobile Telecommunications Service (UMTS) Terrestrial Radio Access Network (eUTRAN).

Access station 210 may include, in addition to transceivers, devices that map one or more RAN slices 212. Each RAN slice 212 may include a logical RAN network portion that represent or comprise physical radio resources (e.g., PRBs, spectra, transmission power, antenna beams, etc.), radio protocol resources (e.g., radio bearers, control plane resources, etc.), and computational resources (e.g., DU capacity, fronthaul/backhaul transport capacity, etc.). In one implementation, RAN slice 212 may be part of a network slice 214.

In one implementation, RAN slice 212 may particularly include a particular number of PRBs at a DU, where the total number of PRBs for the RAN slices 212 at a cell is bound by the bandwidth capacity. For example, a 100 MHz bandwidth cell may include 273 PRBS. After taking 5 PRBs for overhead messaging, RAN slice 212 may have (273−5=) 268 PRBs to divide among them.

In one implementation, each RAN slice 212 may host one or more Protocol Data Unit (PD)U sessions, where each PDU session provides different QoS type services to UEs 102. Furthermore, each RAN slice 212 may be assigned PRBs that access station 210 may use to transfer data from the network to the application on UE 102. Therefore, for example, if a RAN slice X 212 handles communications for three applications the total number of PRBs assigned to RAN slice X 212 is 30 PRBs, the combined PRBs that access station 210 may use to communicate information for the three applications may be 30 PRBs. In addition, depending on the implementation, when RIC 108 assigns PRBs not used by a particular RAN slice X 212 to another RAN slice Y 212, access station 210 may use such assigned PRBs to support communication between RAN slice Y 212 and the UE 102. RIC 108 may allocate the PRBs based on the availability of the PRBs at RAN slice X 212, the QoS traffic priority of the application, or the priority of the RAN slice 212 handling the application communication. As indicated above, RIC 108 may use other policies to assign the available PRBs to other RAN slices 212 that need additional PRBs to avoid PRB starvation.

As further shown, access network 204 may include one or more MEC clusters 211-1 through 211-Z (collectively referred to as MECs 211 or MEC clusters 211 and generically referred to as MEC 211 or MEC cluster 211) and RIC 108. Each MEC cluster 211 may include MEC devices arranged to provide failover mechanisms. Each MEC device may be coupled to an access station 210. Because of its proximity to access station 210 and therefore its proximity to UEs 102 attached to access station 210 via wireless communication links, the MEC devices may provide services to UEs 102 with minimal latency. In some implementations, MEC 211 may include or host network slices 214.

RIC 108 (or an another component in access network 204, such as a CU) may optimize and automate access network functions using AI/ML and/or other logic. RIC 108 may provide near real-time, real-time, and/or non-real-time control to enhance network performance, flexibility, and efficiency for diverse use cases. In one embodiment, RIC 108 may set PRBs that access stations 210 may use to communicate information to/from applications on UE 102 over the wireless connection. That is, RIC 108 may “assign” PRBs to each RAN slice 212.

As described in greater detail below, RIC 108 may instruct access stations 210 to use PRBs, which were first assigned to one RAN slice 212 but not committed for use, to carry traffic associated with an application or another RAN slice 212 based on PRB reallocation policies, such as the policy to allocate the PRBs based on the QoS traffic priority of the application or the priority of the RAN slice 212. Examples of other policies include allocating PRBs based on the maximum allowed loss, and/or the maximum latency allowed, which may be associated with the RAN slice 212 or the application, in accordance with the SLA between the user of UE 102 and the service provider (e.g., the entity operating the provider network). This is described in greater detail below.

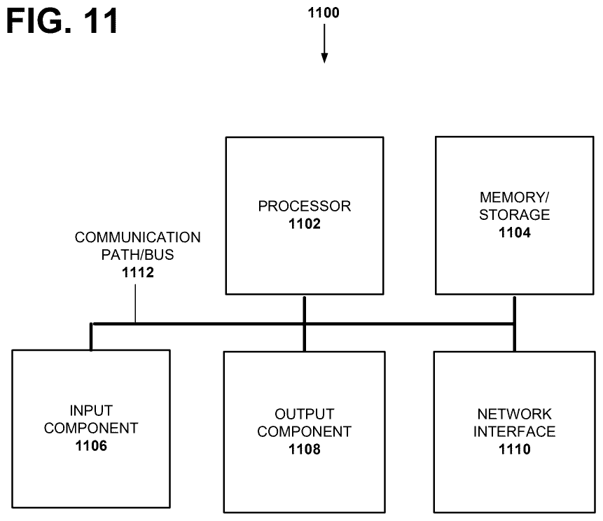

Core network 206 may oversee communication sessions for subscribers connecting via access network 204. For instance, core network 206 may facilitate the establishment of IP connections between UEs 102 and data networks 208. The components within core network 206 can be either dedicated hardware elements or virtualized functions operating atop a shared physical infrastructure using software defined networking (SDN). An SDN controller, for example, may leverage an adapter to implement one or more core network components through virtualized entities like virtual network functions (VNF) virtual machines, cloud native function (CNF) containers, event-driven serverless architecture interfaces, or other SDN components. This shared physical infrastructure may include devices 1100, as described below with reference to FIG. 11, within a cloud computing center associated with core network 206. Moreover, core network 206 may encompass 5G core network components, 4G core network components, or other types of core components.

As further shown, core network 206 may include one or more network slices 214. In some implementations, network slices 214 may include RAN slices 212 implemented via access stations 210. Depending on the embodiment, network slices 214 may be implemented within other networks, such as access network 204 (e.g., in MEC 211) and/or data network 208. Hence, access network 204, core network 206, and data networks 208 may include multiple instances of network slices 214. Each network slice 214 may be instantiated as a result of “network slicing,” which involves a form of virtual network architecture that enables multiple logical networks to be implemented on top of a shared physical network infrastructure using SDN and/or network function virtualization (NFV). Each logical network, referred to as a “network slice,” may encompass an end-to-end virtual network with dedicated storage and/or computational resources that include access network components, clouds, transport network components, central processing unit (CPU) cycles, memory, etc. Furthermore, each network slice 214 may be configured to meet a different set of requirements and may be associated with a particular QoS Class Identifier, a type of service, a 5G QoS Identifier, and/or a particular group of enterprise customers associated with communication devices. Network slices 214 may be capable of supporting enhanced Mobile Broadband (eMBB) traffic, Ultra Reliable Low Latency Communication (URLLC) traffic, Time Sensitive Network (TSN) traffic, Massive IoT (MIoT) traffic, Vehicle-to-Everything (V2X) traffic, High performance Machine Type Communication (HMTC) traffic, and other customized traffic, for example.

Each network slice 214 may be associated with an identifier, herein referred to as a Single Network Slice Selection Assistance Information (S-NSSAI) and/or a network slice instance ID. Each UE 102 that is configured to access a particular network slice 214 may be associated with corresponding data, stored in core network 206 for example, which includes the S-NSSAI that identifies the network slice 214.

Data networks 208 may include one or more networks connected to core network 206. In some implementations, a particular data network 208 may be associated with a data network name (DNN) in 5G and/or an access point name (APN) in 4G. UE 102 may request a connection to data network 208 using a DNN or APN. In a 5G network, data network 208 that is implemented on RAN slice 212 may nonetheless be associated with a DNN. Each data network 208 may include, and/or be connected to and enable communications with, a local area network (LAN), a wide area network (WAN), a metropolitan area network (MAN), an autonomous system (AS) on the Internet, an optical network, a cable television network, a satellite network, another wireless network (e.g., a Code Division Multiple Access (CDMA) network, a general packet radio service (GPRS) network, and/or an LTE network), an ad hoc network, a telephone network (e.g., the Public Switched Telephone Network (PSTN) or a cellular network), an intranet, or a combination of networks. Data network 208 may include an application server (also referred to as application). An application may render services to other applications running on UEs 102 and may establish communication sessions with UEs 102 via core network 206.

For clarity, FIG. 2 does not show all components that may be included in network environment 200 (e.g., routers, bridges, wireless access points, additional networks, additional access stations 210, data centers, portals, etc.). Depending on the implementation, network environment 200 may include additional, fewer, different, or a different arrangement of components than those illustrated in FIG. 2.

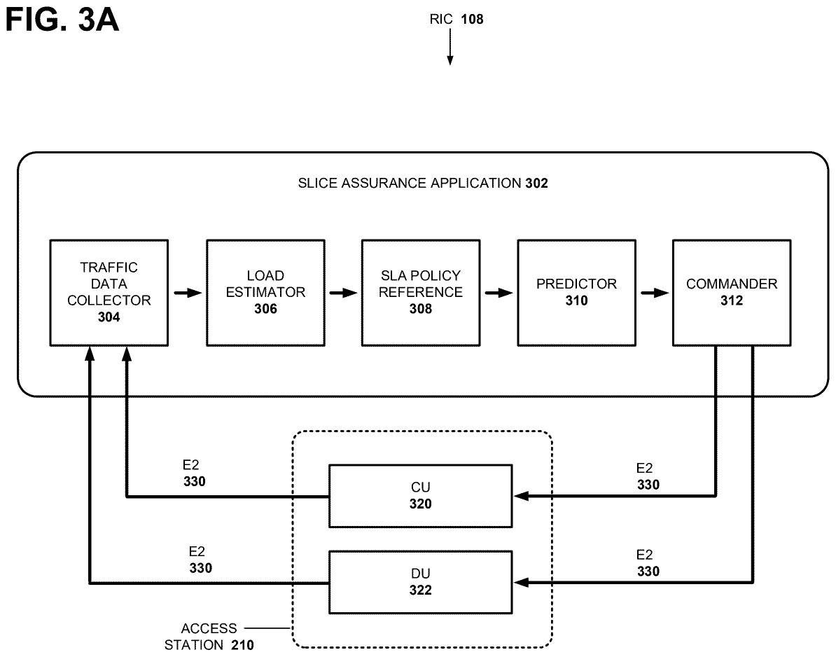

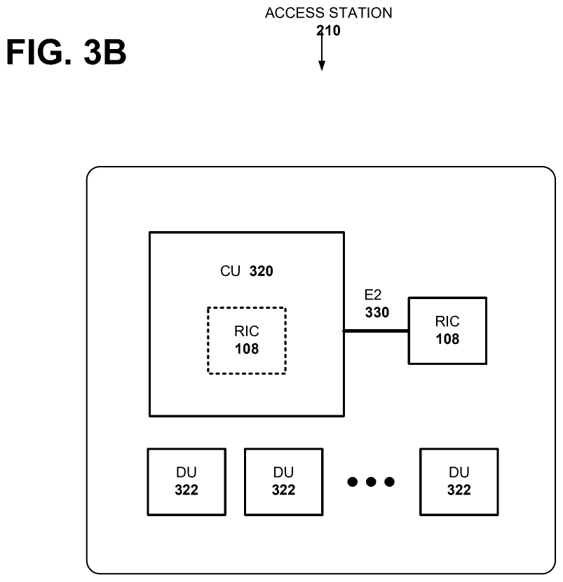

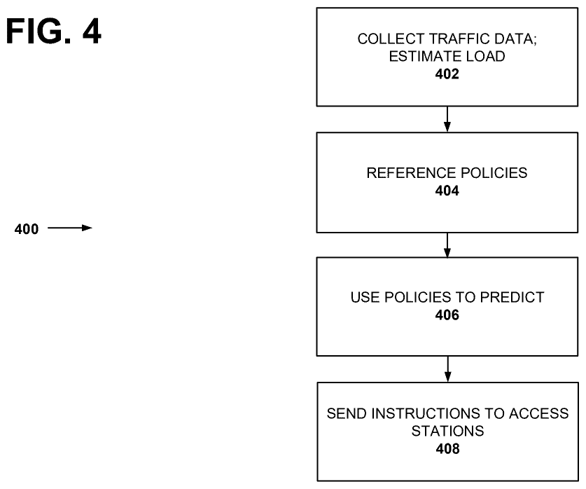

FIG. 3A illustrates exemplary components of RIC 108, according to an implementation. FIG. 4 is a flow diagram of an exemplary process 400 that is associated with RIC 108. FIG. 4 is described below together with FIG. 3A. As shown, RIC 108 may include a slice assurance application 302 that dynamically allocates (or reallocates) PRBs that are originally allocated by RIC 108 to RAN slices 212, to prevent PRB starvation by certain RAN slices 212 or applications whose communication is handled via slices 212.

As further shown, slice assurance application 302 may include a traffic data collector 304, a load estimator 306, an SLA policy reference 308, a predictor 310, and a commander 312. Traffic data collector 304 may obtain traffic data from access stations 210 and/or distributed components of access stations (FIG. 4: block 402), such as CU 320 or DU 320 via an E2 interface 330 or O1 and indirectly via A1 in case of non-Real Time RIC 108. For example, in one implementation, traffic data collector 304 may obtain Key Performance Indicators (KPIs) from access station 210 via the E2 interface 330 or O1 and indirectly via A1 in case of non-Real Time RIC 108. Examples of collected KPI values include: QoS traffic types for one or more applications, a UE connection count, a UE session count (PDU session count for UE 102), a PRB usage per cell, a PRB usage per RAN slice 212, a PRB usage per QoS traffic type, a QoS to slice mapping, a PRBs per UE 102, packet arrival rate per QoS per bearer (e.g., a QoS flow), a time of the day application starts, a time of the day application ends, a number of connections per RAN slice, a radio bearer (QoS flow) throughput, and a UE traffic volume.

Load estimator 306 may evaluate load on each RAN slice 212 and for each QoS traffic types associated with the slice (block 402). More specifically, load estimator 306 may keep count of the number of UEs 102 per each slice 212, number of PDU Sessions per each slice 212 and total GBR UE Throughput per each slice 212. In some implementations, load estimator 306 may identify QoS traffic types and current PRB usages per RAN slice per application for each of the RAN slices 212 based on the obtained KPIs.

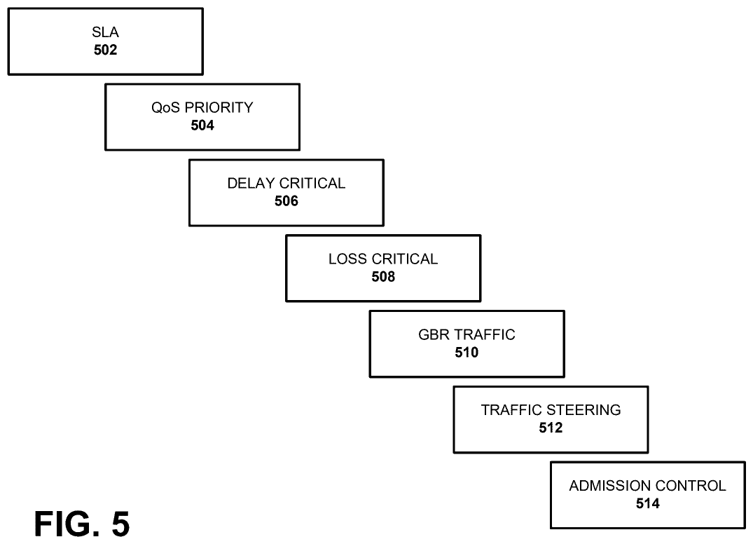

SLA Policy reference 308 may reference one or more allocation policies (block 404). Each policy may specify factors related to SLAs for dynamic allocation of resources. FIG. 5 illustrates example factors of resource allocation precedence. As shown, the factors may include SLA (or parameters specified in the SLA), QoS priority 504, delay critical 506, loss critical 508, GBR traffic 510, traffic steering 512, and admission control 514. Depending on the implementation, the factors may include additional, fewer, different, or a different arrangement of elements than those illustrated in FIG. 5.

QoS priority 504 may relate to the QoS priority (of an application) specified in the SLA; delay critical 506 may relate to the maximum delay threshold indicated in the SLA; loss critical 508 may relate to a maximum data loss threshold indicated in the SLA (e.g., number of permitted loss) indicated in the SLA; GBR traffic 510 may relate to any guaranteed bit rates for a particular service or application specified in the SLA; traffic steering 512 may relate to performance of traffic steering for improving resource availability; and admission control 514 may relate to performing admission control and/or preemption for PRB starvation or allocation. In admission control, if the traffic have equal priorities, to admit a higher priority UE 102, the system may look for RF conditions and pre-empt UEs 102 with bad RF conditions (e.g., lower SINR, CQI, etc.).

Referring back to FIG. 3A, a policy specified by SLA policy reference 308 may indicate, for example, PRB allocation or PRB reallocation based on priority factors 502-510. For example, a policy may specify how available PRBs (e.g., PRBs that were assigned to a RAN slice 212 but are not scheduled to be used) may be dynamically allocated to other RAN slices 212 based on factors 504-510 pertaining to the applications serviced by the RAN slices 212. In another example, a policy may allocate or assign PRBs to particular applications based on one or more factors 504-510.

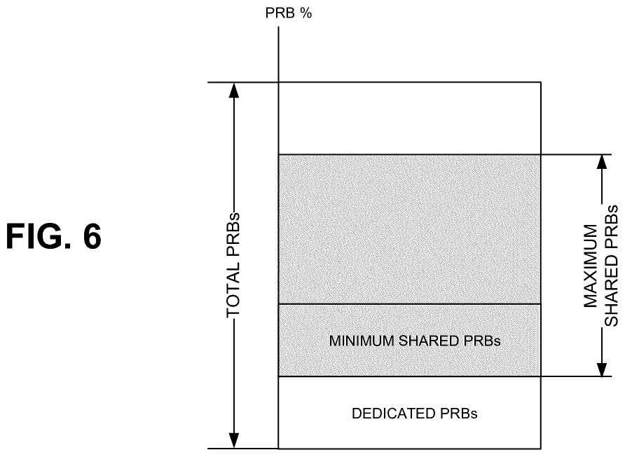

FIG. 6 illustrates an example assignment of PRBs to a RAN slice 212 based on one or more of factors 504-510. As shown, the assignment may include specifying the total number of PRBs, dedicated PRBs, a minimum shared PRBs, and a maximum shared PRBs. The total number of PRBs may indicate the total number of PRBs that are initially assigned to a RAN slice 212; the dedicated PRBs may indicate the minimum number of PRBs that are needed by a RAN slice 212 to meet one or more of the factors 504-510 requirements in the SLA; a minimum shared PRBs may specify the minimum number of PRBs that a RAN slice 212 may share with another RAN slice 212; and the maximum shared PRBs may indicate an upper threshold on PRBs that the RAN slice 212 may share with other RAN slices 212.

Referring back to FIG. 3A, predictor 310 may use the one or more of the referenced policies to predict the traffic (block 406). For example, assuming that RIC 108 has allocated PRBs to RAN slices 212, predictor 310 may calculate any shortage or overage of PRBs as the result of sharing PRBs, which were initially assigned to RAN slice X 212, with RAN slice Y 212. Predictor 310 may select the policies that best meet the SLA requirements (e.g., meets the QoS priority requirements, latency requirements, reliability requirements, etc.).

Commander 312 may receive parameters of the applied policy and issue instructions to access stations 210 (block 408) over the E2 interface 330 or O1 and indirectly via A1 in case of non-Real Time RIC. The instructions may identify, for example, the number of PRBs (e.g., #of PRBs that are reassigned to RAN slice Y 212), an identifier of the RAN slice 212 which is to use the PRBs (e.g., S-NSSAI of RAN slice Y 212), and/or other parameters. Commander 312 may indicate, in its local storage, the #of PRBs that are to be scheduled for use for communication for the particular RAN slice 212,. In some implementations in which access stations 210 include CUs 320 and DUs 322, commander 312 may prepare separate instructions for CUs 320 and DUs 322 (e.g., not all DUs 322 that the CUs 320 controls but only the relevant DU 322). As slice assurance application 302 continues to run, components 304-312 may continue to cycle through the process described by diagram 400.

Depending on the implementation, RIC 108 may include additional applications, such as an application for traffic steering or an application for admission control, or another type of application. A traffic steering application may determine which of the cells neighboring the one that services the UE 102 may provide additional PRBs that meet SLA requirements and perform a handover from the servicing cell to the neighboring cell. An admission control application may determine whether a new session or service request from a UE 102 can be admitted into the network, based on resource availability and QoS requirements; and may allow the network to prioritize higher-priority sessions by reclaiming resources from lower-priority users or services, ensuring critical services meet their QoS requirements.

FIG. 3B illustrates exemplary components of an access station 210 that includes RIC 108, according to a different implementation. In contrast to RIC 108 in FIG. 3A, in FIG. 3B, RIC 108 is included in access station 210. When access station 210 includes CU 320, RIC 108 may be coupled to CU 310 and/or DU 322. In some implementations, the functionalities of RIC 108 may be included within CU 320 rather than without.

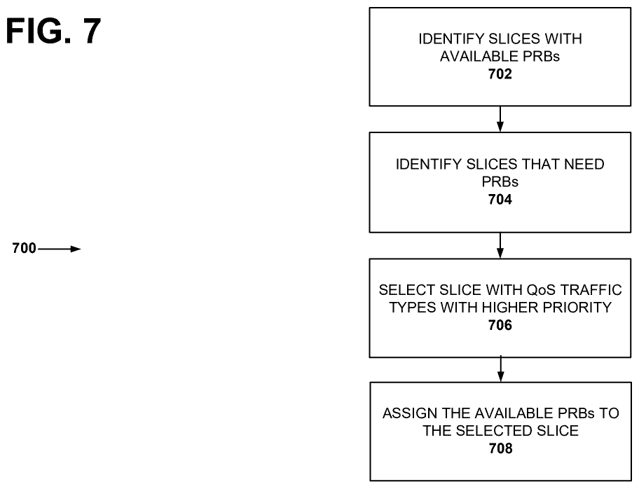

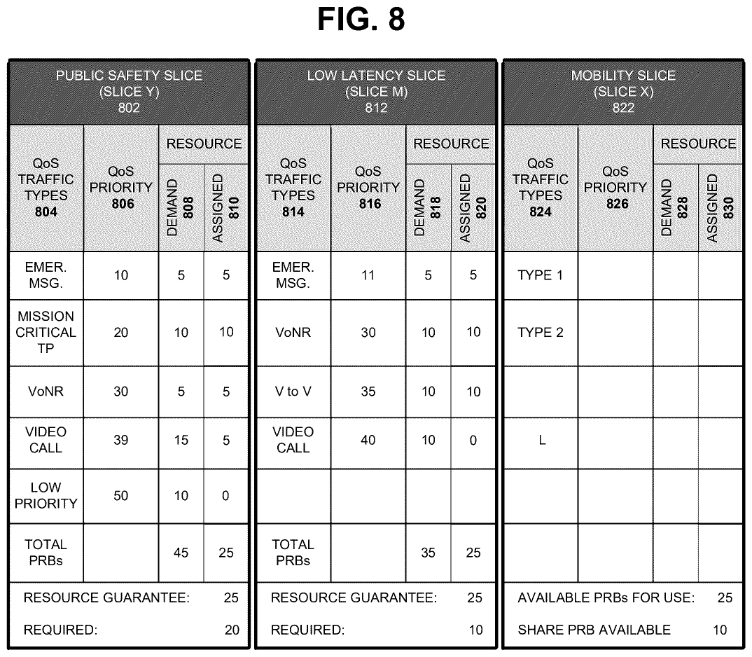

FIG. 7 is a flow diagram of an exemplary process 700 for allocating PRBs that are associated with a RAN slice 212 based on application priorities. Process 700 is implemented by application 302 in RIC 108 by performing process 400 using a QoS priority-based policy. FIG. 8 shows tables of requested and assigned PRBs by applications on different RAN slices 212 during process 700. In particular, table 802 in FIG. 8 includes information regarding requested and assigned PRBs for a public safety slice Y 212; table 812 includes information regarding requested and assigned PRBs for a low latency slice M; and table 822 includes information regarding PRBs for a mobility slice X (values are not shown for many fields). Assume that RIC 108 has the information represented by the tables of FIG. 8.

As shown, process 700 may include identifying RAN slices with PRBs that are available for use by other RAN slices (block 702). In FIG. 8, table 822 (values of many fields are not shown) indicates that the total number of PRBs that RAN slice X 212 may use to service applications hosted on slice X 212 as 25 and the number of available PRBs for servicing applications associated with other slices 212 as 10, which RIC 108 may dynamically allocate for use by another RAN slice 212. RIC 108 may identify such RAN slices 212 by examining the originally assigned number of PRBs and PRBs demanded by all applications serviced by the RAN slice X 212 and computing the difference.

Process 700 may further include identifying RAN slices 212 that need additional PRBs (block 704). For example, table 802 shows the number of PRBs demanded by and assigned to applications of different QoS traffic types. More specifically, table 802 shows public safety slice Y 212 servicing the following QoS types (with a QoS priority): emergency messaging (10), mission critical telephony (20), Voice of NR communication (30), video call (39), and low priority (50). A lower QoS priority number indicates greater importance. The PRBs demanded by the applications of these QoS traffic types and the number of PRBs assigned for use, each represented as a pair <>are: <5, 5>, <10, 10>, <5, 5>, <15, 5>, and <10, 0>. As further shown, the total number of PRBs demanded and assigned are <45, 25>, resulting in the deficit of 20 PRBs. Accordingly, RIC 108 may identify RAN slice Y 212 as one of RAN slices 212 whose applications need additional PRBs.

In another example, table 812 shows PRBs demanded by and assigned to applications of different QoS types. More specifically, table 812 shows a low latency slice M 212 servicing the following QoS types (with a QoS priority): emergency messaging (11), VoNR (30), Vehicle to Vehicle V to V (35), and Video Call (40). The number of PRBs demanded by the applications of these QoS traffic types and the number of PRBs assigned for use, represented as a pair <>are: <5, 5>, <10, 10>, <10, 10>, and <10, 0>. As further shown, the total number of PRBs demanded and assigned are <35, 25>, showing the deficit of 10 PRBs. Accordingly, RIC 108 may identify RAN slice M 212 as one of RAN slices 212 that need (or whose applications need) additional PRBs to meet the SLA.

Process 700 may further include selecting a RAN slice with QoS traffic types with a higher QoS priority (block 706). For example, tables 802 and 812 show that public safety RAN slice Y 212 and low latency RAN slice M 212 will be in PRB deficits of 20 and 10, respectively. Examining the QoS priorities 806 of QoS Traffic Types 804 indicates that the lowest QoS priority applications are serviced by RAN slice Y 212, with 39, compared to applications with QoS priority of 40 serviced by RAN slice M 212, Accordingly, RIC 108 may select RAN slice X 212 as the slice 212 with the higher priority. It is noted that a lower numerical value for QoS priority indicates a higher priority.

Process 700 may further include RIC 108 assigning the available PRBs to the selected RAN slice (block 706) and/or to the QoS traffic type, of the selected RAN slice, with the lowest QoS priority value. For example, RIC 108 may assign 10 blocks available from RAN slice X 212 to RAN slice Y 212 and/or to the QoS traffic type of Video Call (with the QoS priority value of 39). In a different implementation, RIC 108 may assign some PRBs to an application with the priority value of 39, and the remaining PRBs to applications with the priority value of 40 (e.g., no PRBs to applications with the priority value of 50). After assigning the available PRB to the selected RAN slice, RIC 108 may send instructions to access station 210 to schedule the 10 available PRBs for RAN slice X 212 to carry traffic for RAN slice Y and/or to carry traffic for its QoS traffic type Video Call applications (block 708).

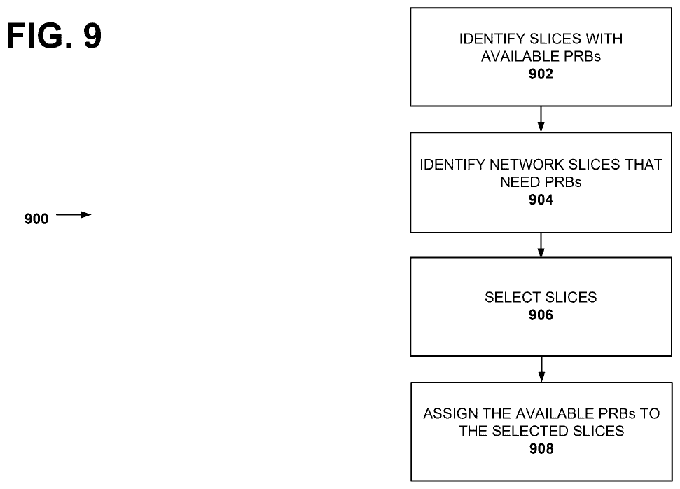

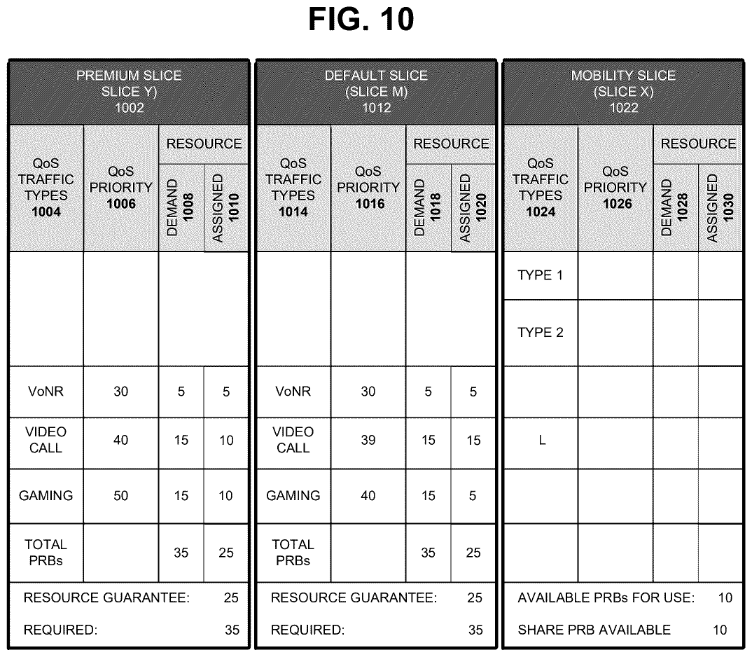

FIG. 9 is a flow diagram of an exemplary process 900 for allocating PRBs that are associated with a RAN slice 212 based on RAN slice priorities. Process 900 is implemented by application 302 in RIC 108 performing process 400 using RAN slice priority-based allocation policy. FIG. 10 shows tables of numbers of demanded and assigned PRBs by applications of particular QoS traffic types on different RAN slices 212 during process 900. Assume that RIC 108 has the information represented by the tables of FIG. 10.

As shown, process 900 may include identifying RAN slices with PRBs that are available for use by other RAN slices (block 902). In FIG. 10, table 1022 of demanded (or requested) and assigned PRBs shows that the total number of PRBs that RAN slice X 212 may use to service applications hosted on slice X 212 is 10 and the number of available PRBs for servicing applications hosted by other slices 212 is 10. Thus, 10 PRBs may be dynamically allocated for use by another RAN slice 212. RIC 108 may identify such RAN slices 212 by examining the number of demanded PRBs and the number of assigned PRBs by all applications serviced by the RAN slice X 212 and computing the difference.

Process 900 may further include identifying RAN slices 212 that need additional PRBs (block 904). For example, table 1002 shows the number of PRBs demanded by and assigned to applications of different QoS types. More specifically, table 1002 shows premium slice 212 servicing the following QoS traffic types (with a QoS priority): VoNR (30), video call (40), and gaming (40). The number of PRBs demanded by the applications of these QoS traffic types and the number of PRBs assigned or committed for use, each represented as a pair <>, are: <5, 5>, <15, 10>, and <15, 10>. As further shown, the total number of PRBs demanded and assigned are <35, 25>, resulting in the deficit of 10 PRBs. Accordingly, RIC 108 may identify RAN slice 1002 as one of RAN slices Y 212 that need PRBs to avoid PRB starvation.

In another example, table 1012 shows the number of PRBs demanded by and assigned to applications of different QoS traffic types. More specifically, table 1012 shows a default slice M 212 that services applications of the following QoS traffic types (with a QoS priority): VoNR (30), video call (39), and gaming (40). The number of PRBs demanded by the applications of these QoS traffic types and the number of PRBs assigned for use, each represented as a pair <>, are: <5, 5>, <15, 15>, and <15, 5>. As further shown, the total number of PRBs demanded by and assigned to slice M 212 are <35, 25>, resulting in the deficit of 10 PRBs. Accordingly, RIC 108 may identify RAN slice M 1012 as one of RAN slices 212 that need PRBs to avoid PRB starvation.

Process 900 may further include selecting a RAN slices (block 906). For example, tables 1002 and 1012 show that the premium slice Y 212 and the default slice M 212 will be in PRB deficits of 10 and 10, respectively. RIC 108 may select the highest priority slice (i.e., the premium slice 212) or both of the RAN slices for receiving the available PRBs.

Process 900 may further include RIC 108 assigning the available PRBs to the selected RAN slices 212 (block 906). In one implementation, where the highest priority RAN slice 212 is selected, the entirety of the available PRBs may be assigned to RAN slice Y 212. In a different implementation, where the available slices are distributed to multiple selected slices 212 that need additional PRBs 212, the premium RAN slice 212 may get 50% of the available PRBs and the default RAN slice 212 may get the 50% of the available PRBs.

Within a RAN slice 212, if two or more QoS traffic types with equal QoS priority demand PRBs, RIC 108 may select one QoS traffic type over another based on their RF conditions, such as for example, a Channel Quality Index (CQI), a Signal and Interference to Noise Ratio (SINR), and a Reference Signal Received Power (RSRP). That is, RIC 108 may select the QoS traffic type with favorable RF conditions and all of the newly allocated PRBs for the RAN slice to the selected QoS traffic type. After assigning the available PRB to the selected RAN slices 212 and/or QoS traffic types, RIC 108 may send instructions to access station 210 to schedule the 10 available PRBs for the selected RAN slices 212 and/or the QoS traffic types.

FIG. 11 depicts exemplary components of a network device 1100. Network device 1100 may correspond to or be included in any of the devices and/or components illustrated in FIGS. 1-3 (e.g., UE 102, RIC 108, access network 204, core network 206, data network 208, access station 210, and RAN slices 212). In some implementations, network devices 1100 may be part of a hardware network layer on top of which other network layers and network functions may be implemented.

As shown, network device 1100 may include a processor 1102, memory/storage 1104, input component 1106, output component 1108, network interface 1110, and communication path 1112. In different implementations, network device 1100 may include additional, fewer, different, or different arrangement of components than the ones illustrated in FIG. 11. For example, network device 1100 may include line cards, switch fabrics, modems, etc.

Processor 1102 may include a processor, a microprocessor, an Application Specific Integrated Circuit (ASIC), a Field Programmable Gate Array (FPGA), programmable logic device, chipset, application specific instruction-set processor (ASIP), system-on-chip (SoC), central processing unit (CPU) (e.g., one or multiple cores), microcontrollers, and/or other processing logic (e.g., embedded devices) capable of controlling network device 1100 and/or executing programs/instructions.

Memory/storage 1104 may include static memory, such as read only memory (ROM), and/or dynamic memory, such as random access memory (RAM), or onboard cache, for storing data and machine-readable instructions (e.g., programs, scripts, etc.). Memory/storage 1104 may also include a CD ROM, CD read/write (R/W) disk, optical disk, magnetic disk, solid state disk, holographic versatile disk (HVD), digital versatile disk (DVD), and/or flash memory, as well as other types of storage device (e.g., Micro-Electromechanical system (MEMS)-based storage medium) for storing data and/or machine-readable instructions (e.g., a program, script, etc.). Memory/storage 1104 may be external to and/or removable from network device 1100.

Memory/storage 1104 may include, for example, a Universal Serial Bus (USB) memory stick, a dongle, a hard disk, off-line storage, a Blu-Ray® disk (BD), etc. Memory/storage 1104 may also include devices that can function both as a RAM-like component or persistent storage, such as Intel® Optane memories. Depending on the context, the term “memory,” “storage,” “storage device,” “storage unit,” and/or “medium” may be used interchangeably. For example, a “computer-readable storage device” or “computer-readable medium” may refer to both a memory and/or storage device.

Input component 1106 and output component 1108 may provide input and output from/to a user to/from network device 1100. Input/output components 1106 and 1108 may include a display screen, a keyboard, a mouse, a speaker, a microphone, a camera, a DVD reader, USB lines, and/or other types of components for obtaining, from physical events or phenomena, to and/or from signals that pertain to network device 1100.

Network interface 1110 may include a transceiver (e.g., a transmitter and a receiver) for network device 1110 to communicate with other devices and/or systems. For example, via network interface 1110, network device 1100 may communicate over a network, such as the Internet, an intranet, cellular, a terrestrial wireless network (e.g., a wireless LAN, WIFI, WIMAX, etc.), a satellite-based network, optical network, etc. Network interface 1110 may include a modem, an Ethernet interface to a LAN, and/or an interface/connection for connecting network device 1100 to other devices (e.g., a Bluetooth interface).

Communication path or bus 1112 may provide an interface through which components of network device 1100 can communicate with one another.

Network device 1100 may perform the operations described herein in response to processor 1102 executing software instructions stored in a non-transient computer-readable medium, such as memory/storage 1104. The software instructions may be read into memory/storage 1104 from another computer-readable medium or from another device via network interface 1110. The software instructions stored in memory/storage 1104, when executed by processor 1102, may cause processor 1102 to perform one or more of the processes that are described herein.

In this specification, various preferred embodiments have been described with reference to the accompanying drawings. It will be evident that modifications and changes may be made thereto, and additional embodiments may be implemented, without departing from the broader scope of the invention as set forth in the claims that follow. The specification and drawings are accordingly to be regarded in an illustrative rather than restrictive sense.

In the above, while series of actions, messages, and/or signals have been described with reference to FIGS. 4, 7, and 9. the order of the actions, messages, and signals may be modified in other implementations. In addition, non-dependent actions, messages, and signals may represent actions, messages, and signals that can be performed, sent, and/or received in parallel and in different orders. Furthermore, each of actions, messages, and signals illustrated may include one or more other actions, messages, and/or signals.

As used above, the term “session” may refer to a series of communications, of a limited duration, between two endpoints (e.g., two applications). When a session is established between an application and a network or a network slice, the session is established between the application and another application/server hosted by the network or the network slice. Similarly, if a session is established between a device and a network slice or a network, the session is established between an application on the device and another application on either the network slice or the network.

In addition, the term PDU session (a protocol data unit session) or PDN session (a packet data network session) may refer to communication between a mobile device and another endpoint (e.g., a data network, a network slice, etc.). Depending on the context, the term “session” may refer to a PDU session, a PDN session, or a session between applications. Additionally, depending on the context, the term “connection” may refer to a session, a PDU session, a PDN session, or another type of connection (e.g., a radio frequency link between a device and a base station).

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

Further, certain portions of the implementations have been described as “logic” that performs one or more functions. This logic may include hardware, such as a processor, a microprocessor, an application specific integrated circuit, or a field programmable gate array, software, or a combination of hardware and software.

To the extent the aforementioned embodiments collect, store or employ personal information provided by individuals, it should be understood that such information shall be collected, stored, and used in accordance with all applicable laws concerning protection of personal information. The collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

No element, block, or instruction used in the present application should be construed as critical or essential to the implementations described herein unless explicitly described as such. Also, as used herein, the articles “a,” “an,” and “the” are intended to include one or more items. Further, the phrase “based on” is intended to mean “based, at least in part, on” unless explicitly stated otherwise.

What is claimed is:

1. A device comprising a processor configured to:
identify first Radio Access Network (RAN) slices with more physical resource blocks (PRBs) assigned to the first RAN slices than a number of PRBs that the first RAN slices need for first radio access network (RAN) communication from an access station to User Equipment devices (UEs);
identify one or more second RAN slices that need more PRBs than a number of PRBs assigned to the one or more second RAN slices for second RAN communication from the access station to UEs; and
instruct the access station to schedule PRBs that are not needed by the first RAN slices or preset PRBs for third RAN slices for the second RAN communication to the UEs.

2. The device of claim 1, wherein the processor is further configured to:
receive traffic data from the access station; and
obtain service level agreement (SLA) information, wherein when identifying the second RAN slices, the processor is configured to:
identify the second RAN slices based on the traffic data and the SLA information.

3. The device of claim 2, wherein the SLA information includes at least one of:
Guaranteed Bit Rate (GBR) information;
Latency information; or
Reliability information.

4. The device of claim 3, wherein the traffic data includes at least one of:
QoS traffic types for one or more applications;
a UE connection count;
a PRB usage per cell;
a PRB usage rate per RAN slice;
a PRB usage rate per QoS traffic type;
a QoS to slice mapping;
a PRBs per UE;
a number of connections per RAN slice;
a radio bearer throughput;
a UE Protocol Data Unit (PDU) session count; or a UE traffic volume.

5. The device of claim 4, where the processor is further configured to:
estimate, based on the traffic data and/or Radio Frequency (RF) conditions between the UEs and the access station,, a number of PRBs that each of the first RAN slices needs for the first RAN communication to the UEs.

6. The device of claim 4, wherein the processor is further configured to:
perform, based on the traffic data, traffic steering for UEs; or
based on the traffic data, have the access station perform admission control and preemption.

7. The device of claim 1, wherein when identifying the second RAN slices, the processor is configured to:
identify the second RAN slices by identifying at least a RAN slice which services applications whose Quality-of-Service (QoS) priorities are lower than those of other RAN slices.

8. The device of claim 1, wherein when identifying the second RAN slices, the processor is configured to:
identify the second RAN slices by identifying RAN slices which have the highest priorities.

9. The device of claim 8, wherein after identifying the second RAN slices, the processor is configured to:
identify applications which are in need of additional PRBs for the second RAN communication and which have the lowest Quality-of-Service (QoS) priority values.

10. The device of claim 9, wherein after identifying the applications, the processor is configured to:
if two applications have an equal QoS priority value, selecting, from the two applications, an application with a higher radio frequency (RF) channel quality.

11. A method comprising:
identifying first Radio Access Network (RAN) slices with more physical resource blocks (PRBs) assigned to the first RAN slices than a number of PRBs that the first RAN slices need for first radio access network (RAN) communication from an access station to User Equipment devices (UEs);
identifying one or more second RAN slices that need more PRBs than a number of PRBs assigned to the one or more second RAN slices for second RAN communication from the access station to UEs; and
instructing the access station to schedule PRBs that are not needed by the first RAN slices or preset PRBs for third RAN slices for the second RAN communication to the UEs.

12. The method of claim 11, further comprising:
receiving traffic data from the access station; and
obtaining service level agreement (SLA) information, wherein identifying the second RAN slices includes:
identifying the second RAN slices based on the traffic data and the SLA information.

13. The method of claim 12, wherein the SLA information includes at least one of:
Guaranteed Bit Rate (GBR) information;
Latency information; or Reliability information.

14. The method of claim 13, wherein the traffic data includes at least one of:
QoS traffic types for one or more applications;
a UE connection count;
a PRB usage per cell;
a PRB usage rate per RAN slice;
a PRB usage rate per QoS traffic type;
a QoS to slice mapping;
a PRBs per UE;
a number of connections per RAN slice;
a radio bearer throughput;
a YE Protocol Data Unit (PDU) session count; or
a UE traffic volume.

15. The method of claim 14, further comprising:
estimating, based on the traffic data and/or Radio Frequency (RF) conditions between the UEs and the access station,, a number of PRBs that each of the first RAN slices needs for the first RAN communication to the UEs.

16. The method of claim 14, wherein further comprising:
perform, based on the traffic data, traffic steering for UEs; or
based on the traffic data, have the access station perform admission control and preemption.

17. The method of claim 11, wherein identifying the second RAN slices comprises:
identifying the second RAN slices by identifying at least a RAN slice which services applications whose Quality-of-Service (QoS) priorities are lower than those of other RAN slices.

18. The method of claim 11, wherein identifying the second RAN slices includes:
identifying the second RAN slices by identifying RAN slices which have the highest priorities.

19. The method of claim 18, further comprising:
identifying applications which are in need of additional PRBs for the second RAN communication and which have the lowest Quality-of-Service (QoS) priority values.

20. A non-transitory computer-readable medium comprising processor-executable instructions, which when executed by a processor, cause the processor to:
identify first Radio Access Network (RAN) slices with more physical resource blocks (PRBs) assigned to the first RAN slices than a number of PRBs that the first RAN slices need for first radio access network (RAN) communication from an access station to User Equipment devices (UEs);
identify one or more second RAN slices that need more PRBs than a number of PRBs assigned to the one or more second RAN slices for second RAN communication from the access station to UEs; and
instruct the access station to schedule PRBs that are not needed by the first RAN slices for the second RAN communication to the UEs.
